(19) United States
(12) Patent Application Publication
(10) Pub. No.: US 2016/0267444 A1
(43) Pub. Date: Sep. 15, 2016

(54) Payments through Virtualization of a Physical Point of Sale (POS) Terminal and Money Transfer Using Mobile Device

(71) Applicant: MARK MATHENGE MUTAHI, NAIROBI (KE)

(72) Inventor: MARK MATHENGE MUTAHI, NAIROBI (KE)

(21) Appl. No.: 15/062,223

(22) Filed: Mar. 7, 2016

Related U.S. Application Data
(60) Provisional application No. 62/131,255, filed on Mar. 11, 2015.

(51) Int. Cl. G06Q 20/02; G06Q 20/32; G06Q 20/40; G06Q 20/36

(52) U.S. Cl. CPC G06Q 20/027; G06Q 20/363; G06Q 20/3227; G06Q 20/401

(57) ABSTRACT

The invention relates to financial technology, mobile banking and mobile money transfer service industries. The current problem is that it is expensive to install credit/debit card readers at local stores. There is also the issue of risk of exposing card details to skimmers during POS transactions and during filling of forms in online transactions. The present invention simplifies the transaction and allows a user to pay for goods/services at a physical or online store without exposing their card details and without the merchant installing card reader. It also allows for a convenient global mobile-initiated bank to bank transfer of money. The invention may be used for money transfer between accounts that authenticate user's phone number or email addresses. The invention may also be used in the field of security technology to provide access to resources from a mobile device by use of pre-stored access credentials.

### CROSS-REFERENCE TO RELATED APPLICATIONS

This application claims the benefit of U.S. Provisional Application No. 62131255 filed 2015 Mar. 11.

### STATEMENT REGARDING FEDERALLY SPONSORED RESEARCH OR DEVELOPMENT

Not Applicable

### BACKGROUND OF THE INVENTION

Regular physical Point of Sale (POS) terminals require a physical credit/debit card reader to read card information from a physical card. This has a huge costs implication to the merchants who also require their clients have with them; their credit/debit cards for the transaction to be processed, which pose a security risk (physical theft as well as credit card information theft using skimmers), susceptibility to loss, defacing through ‘wear and tear’ as well as issues simply forgetting to carry the card.

Explicit input of payment card details on online payment forms also creates a security problem as hackers may ‘sniff-out’ the card details for fraudulent re-use.

Regular mobile-based payment systems do not provide for convenient money transfer from card issuing bank account to a recipient/acquiring bank account through mobile devices. This results to high overhead costs and inconvenience while trying to move money from one account to a receiving account.

### BRIEF SUMMARY OF THE INVENTION

The invention allows a merchant at a physical Point of Sale (POS) terminal to accept credit/debit/ATM card payments without having to physically swipe their client's credit/debit/ATM cards and without the need of installing a physical card reader/machine. The only ‘requirement’ being registration and linking of their business and account details (into which they will receive payments). An identifier such as a Merchant ID number is linked to their receiving bank account. This greatly reduces the cost, increases security as card details are not explicitly exposed and also reduces the excess baggage of having to always carry your debit/credit card which may be exposed to loss/defacement.

The invention also allows a payee to receive money from a payer who previously links their credit/debit (ATM) card information to their mobile device unique identifier (such as phone number) and authorizes transfer to a recipient unique identifier-linked account using a mobile device. The transfer is through an online gateway as directed by commands and input from the mobile device. The only ‘requirement’ being pre-registration and linking of the payee/recipient identifier to recipient account, without which, the server auto-generates a virtual currency worth that amount, such as virtual debit/credit card and automatically links it to the recipient identifier.

The invention may also be implemented in the computerized security field as a security/resource access feature that allows an authorized mobile device holder, access to pre-store their access credentials, which thereafter may be used to grant them remote access to a secured resource via mobile device.

### BRIEF DESCRIPTION OF THE DRAWINGS

FIG. 1 shows a general process flow chart for assigning a recipient identifier and linking it to a recipient bank account.

FIG. 2 illustrates the process of linking of mobile device identifier (such as phone number) to the card information that is input through the mobile device.

FIG. 3 shows the payment process flow chart for making payments at a physical Point of Sale (POS) terminal.

FIG. 4 presents a conceptual illustration of the invention concept and relation between different elements.

### DETAILED DESCRIPTION AND BEST MODE OF IMPLEMENTATION

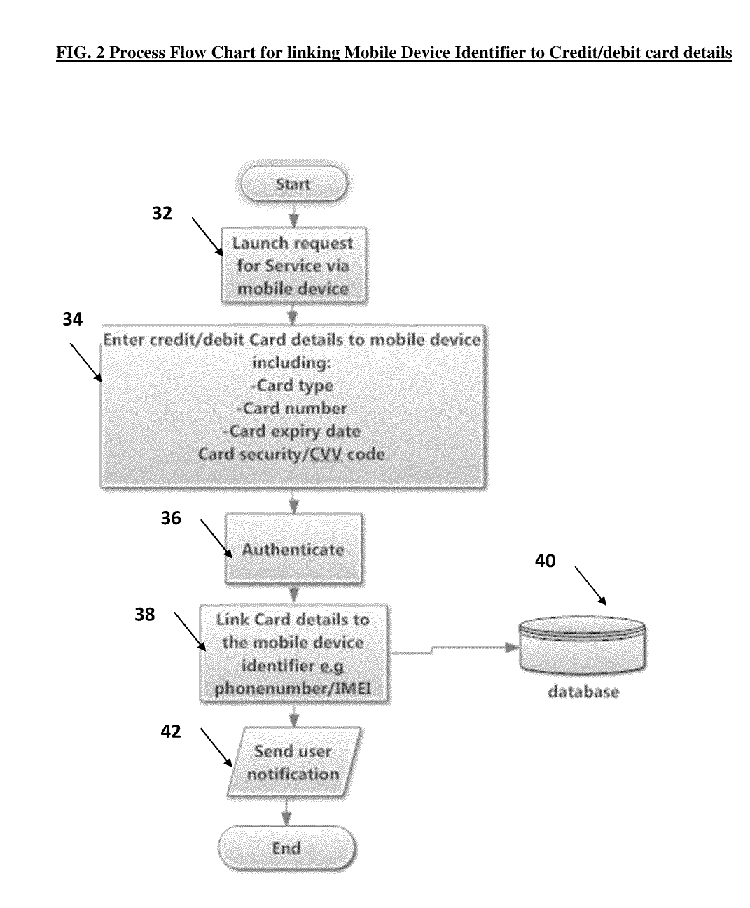

FIG. 2 shows how initially a payer may register with the system, this is one-time registration event where the user initiates the service 32, adds and links 38 their payment instrument , such as credit/debit card information 34, to their mobile device identifier 38 such as their phone number to the system. This added/linked information 34 may include the type of credit/debit card, card number, card expiry date and security code/CVV. This may be done from a mobile device using a user-specific communication protocol such as USSD/SMS/IP over a GPRS/GSM or IP-Based USSD and authentication via PIN and/or an authentication 36, Call/SMS sent via a GPRS/GSM/IP network or through a Personal Identification Number (PIN) 36. Optionally, the registration, adding and linking may be done automatically on generation of a virtual debit/credit card or directly at the card issuing bank. The registration/linking here means associating card information or account information to a mobile device identifier such as a device number, phone number or IMEI. This information is securely stored on a cloud server/database 40 for later use during actual payment. A notification 42 may be sent to the potential payer/sender indicating the registration status.

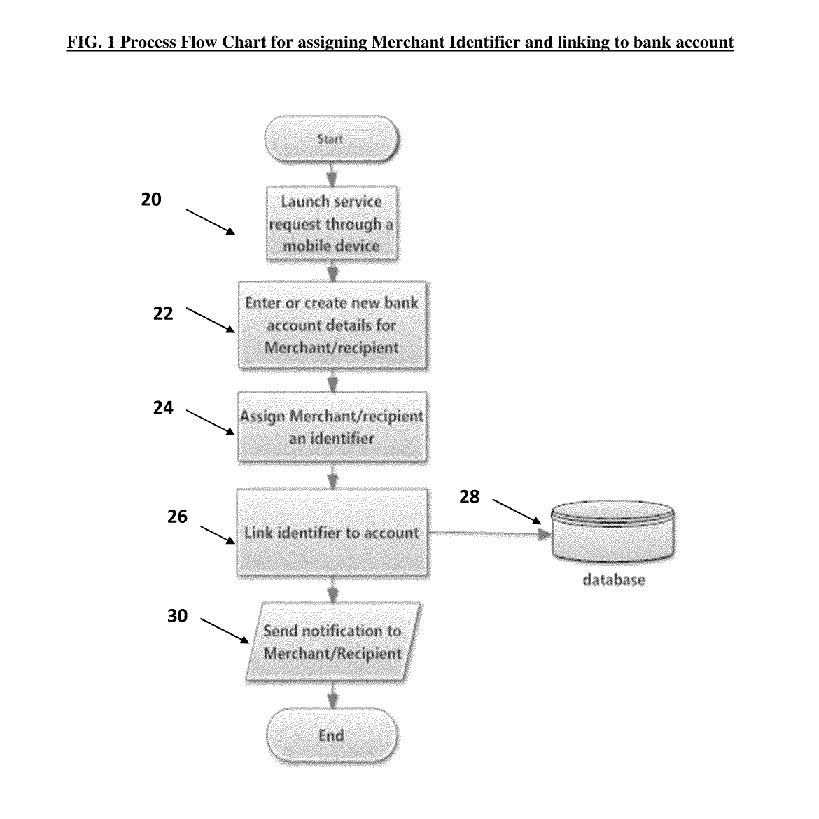

FIG. 1 shows how initially a merchant may launch the service 20 and register with the system, this is ideally a one-time event that includes adding and linking of their recipient account details 22 to an assigned identifier such as merchant ID 24. Registration may be done via the mobile device, through email request or directly by the virtualization service provider. The registration/linking 26, here means associating the merchant/recipient's account information 22, or receiving account information to a payee identifier 24, such as a merchant number or phone number. This information may be securely stored on a cloud server/database 28 for later use during actual payment. A notification 30 may be sent to the payee indicating the registration status.

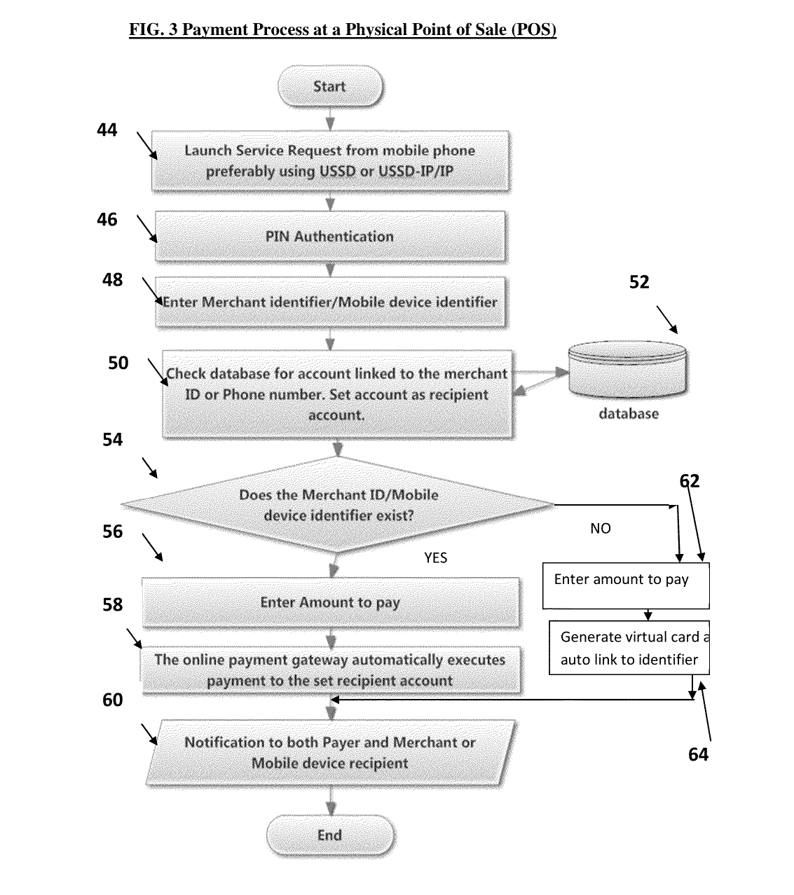

FIG. 3 shows how a registered payer can make payments. The user may initiate payment by launching the service 44. Authentication 46, via PIN/Identifier or a combination may be done at this point or later depending on the security requirements. The payer then inputs the receiving entity's identifier 48, such as the merchant ID/code or phone number. The system may check 50 for the identifier 48, in the system database 52, to ascertain recipient registration status 54 and if registered, it sets the receiving account as the account linked to the identifier 48. If not available on the system database, the amount to be paid may be specified 62, and a virtual card generated 64, and auto-linked to the identifier 48 and notifications 60, sent out to both payer/payee or sending and receiving parties about the transaction status. However, should the identifier 48, be found in the system, the amount to be paid/sent 56, may be input by the user on their mobile device and sent to the system for further processing.

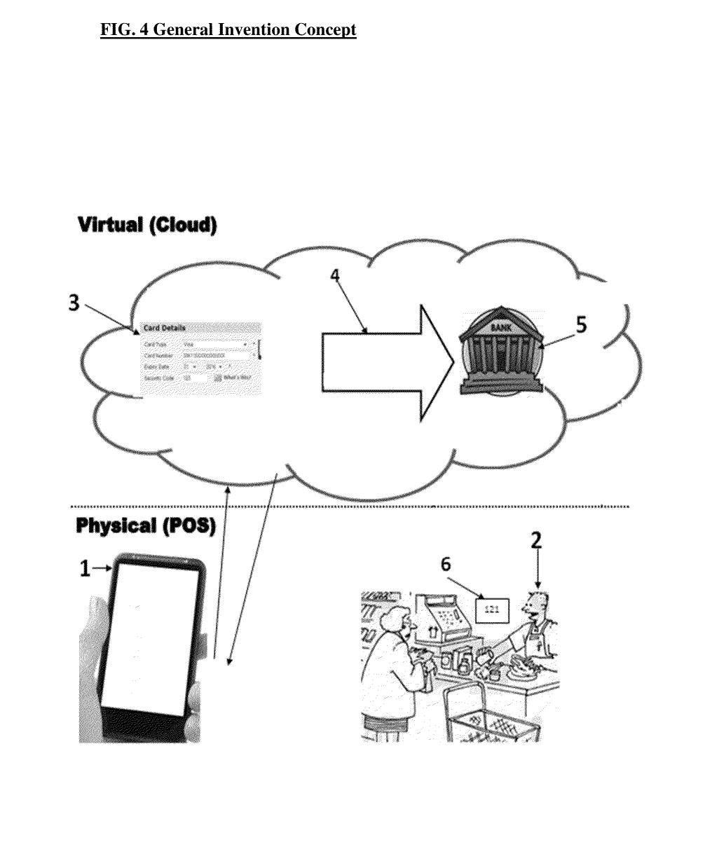

At this point, we have all that is required to complete an online transaction through an online gateway 58, depending on the availability of funds in the issuing account. We have the pre-stored/pre-linked card information that is linked and defined by the payer's identifier initiating/making the payment request, which includes the card type, card number, expiry and CVV code and the necessary authentication as shown in FIG. 2. This can be conceptually viewed or thought of, as shown in FIG. 4, as a pre-filled online check out form 3. Pre-filled by the earlier linked card information from the payer's identifier-linked card information. This automatically executes action by the online payment gateway 4, to transfer funds from the issuing bank account to the set merchant account 5 as defined and linked by the payee/recipient identifier 6. Once the transaction is complete both the payer and payee 2 receive confirmation notifications on the status of the transaction on the mobile device 1.

Preferably, during user authentication, native USSD should be used as GPRS/GSM inherently provides authentication/security as there can be only one unique phone number in the GPRS/GSM network. Optionally, IP-based USSD may be used together with an IMEI and/or GSM communication method such as phone call or SMS to validate authenticity of the session initiator. The latter being suitable for implementation through smart mobile device application.

The present invention may also be implemented on online payment platforms, where instead of having users expose their card details online when inputting them in a payment form, an identifier (such as a numerical merchant ID or QR merchant code) for the online merchant is assigned and displayed on the checkout form and the user pays using mobile device to the identifier.

The method may also be used for money transfer between social media and other online accounts (including email) that authenticate users using their mobile phone numbers. As the mobile phone numbers may have card information/account linked to them.

The present invention may also link an email account to the device identifier such as the phone number to allow money transfer and payments through payment gateways that authenticate users using their email addresses.

The invention may also be implemented in the computerized security field as a security/resource access feature that allows an authorized mobile device holder access to pre-store their access credentials, which thereafter may grant them remote access to a secured resource via mobile device.

What is claimed is:

1. A computer-implemented method for making payments or money transfer comprising:
a payee/recipient identifier (that uniquely represents a receiving entity or account) which is provided as user input into;
a mobile device that is linked to a payment instrument (such as a credit/debit or prepaid card information) for said information to be processed through;
an online payment gateway, switch or mapping table to facilitate transfer of funds from the payment instrument's account to the account associated with the receiving identifier.

2. The method of claim 1, wherein the credit/debit or prepaid card information is characterized by card type or payment network, the card number, the security/CVV code/PIN, card value and the expiry date.

3. The method of claim 1, wherein the payment gateway/switch or mapping table is characterized by a dynamic receiving account (merchant acquirer or sub-merchant account) as defined and determined by the payee identifier.

4. The method of claim 1, wherein the said payment or money transfer is made online or at a physical Point of Sale (POS)/Checkout terminal.

5. The method of claim 1, wherein the recipient identifier is characterized by at least one or a combination of elements of the type: numeric, alpha-numeric, special characters, wave (for example magnetic/radio/Wi-Fi), images/symbols (such as QR codes) or any abstraction that can uniquely identify and distinguish a payee with the respective associated account.

6. The method of claim 1, further comprising: assigning a recipient identifier to a payee and linking the identifier to a receiving account (merchant acquirer or sub-merchant account).

7. The method of claim 1, further comprising: assigning the mobile device a payer identifier (such as mobile number, device ID, account/user ID or application ID) and linking the payer identifier to the payment instrument such as virtual currency/credit/debit card information.

8. The method of claim 1, further characterized by the process of linking the payee identifier to generated virtual currency/card for a payee identifier that is not previously linked to an account.

9. A method for sending money, which method includes the steps of:
assigning the sender a sender identifier such as a phone number, user ID or email;
linking of the sender identifier to a payment instrument such as virtual currency or debit/credit/prepaid card information;
assigning the recipient a recipient identifier such as a phone number, user ID or email;
assigning or linking the recipient identifier a receiving account;
issuing of a request/command from a mobile device by the sender to initiate and facilitate transfer of funds from the account associated with the payment instrument to the receiving account, using the linked virtual currency or debit/credit/prepaid card information, through an online payment gateway, switch or mapping table.

10. The method of claim 9, wherein the credit/debit card information is characterized by card type, the card number, the security/CVV code/PIN, card value and the expiry date.

11. The method of claim 9, wherein the recipient identifier is characterized by at least one or a combination of elements of the type: numeric, alpha-numeric, special characters, wave (for example magnetic/radio/Wi-Fi), images or symbols (such as QR codes that identify and distinguish a payee and the respective associated account).
